(19) United States
(12) Patent Application Publication
(10) Pub. No.: US 2015/0205051 A1
(43) Pub. Date: Jul. 23, 2015

(54) Boot For An Optical Fiber Connector

(71) Applicant: Amphenol Fiber Optic Technology (Shenzhen), Shenzhen City (CN)

(72) Inventors: Xue-Wu LEI, Shenzhen City (CN); Song-Sheng LI, Shenzhen City (CN); Min CHEN, Shenzhen City (CN); Jun-Quan BAO, Shenzhen City (CN)

(73) Assignee: Amphenol Fiber Optic Technology (Shenzhen), Shenzhen City (CN)

(21) Appl. No.: 14/278,592

(22) Filed: May 15, 2014

(30) Foreign Application Priority Data
Jan. 20, 2014 (TW) 103201158

(51) Int. Cl. G02B 6/36; G02B 6/38

(52) U.S. Cl. CPC G02B 6/3616; G02B 6/3887

(57) ABSTRACT

A boot for cooperating with a head piece to serve as an optical fiber connector includes a positioning piece and a curved tube. The positioning piece is connected to the headpiece and has two parallel through holes. The curved tube has a curved tubular section and an affixing sleeve section. The curved tubular section is connected to the positioning piece, and is formed with an elongated groove that extends along length of the curved tubular section, such that two optical fiber lines coupled to the headpiece through the positioning piece are installed into the curved tubular section via the groove. The affixing sleeve section is connected to the curved tubular section, and is adapted for affixing portions of the optical fiber lines thereon.

### CROSS-REFERENCE TO RELATED APPLICATION

This application claims priority of Taiwanese Application No. 103201158, filed on Jan. 20, 2014.

### BACKGROUND OF THE INVENTION

1. Field of the Invention

The invention relates to a boot, more particularly to a boot for an optical fiber connector.

2. Description of the Related Art

Optical fiber lines are made of extruded glass or plastic, and are widely used in communication field. In long-distance communication, several optical fiber lines are interconnected by optical fiber connectors and mating sockets to form a longer optical fiber line. There are several conventional optical fiber connectors, such as Lucent connector (LC), Subscriber connector (SC), Ferrule connector (FC) and so on. Lucent connectors are typically applied in high-density communication such as enterprise network, and are connected to mating sockets in a snap-fit manner.

Referring to FIG. 1, a conventional Lucent connector 1 is adapted to establish terminals of two optical fiber lines 13, and includes a head piece 12 and two flexible boots 11 connected to the head piece 12. When the conventional Lucent connector 1 is used in a narrow space, the boots 11 may need to be bent. In such circumstances, the optical fiber lines 13 are first inserted into the boots 11, respectively. Then the boots 11 are manually bent and connected to the head piece 12 to couple the optical fiber lines 13 to a ferrule (not shown) mounted in the head piece 12. The abovementioned assembling process is laborious.

### SUMMARY OF THE INVENTION

Therefore, the object of the present invention is to provide a boot that can overcome the aforesaid drawbacks of the prior art.

Accordingly, a boot of the present invention is adapted for cooperating with a head piece to serve as an optical fiber connector, and includes a positioning piece and a curved tube. The positioning piece is connected to the headpiece, and has two parallel through holes formed therethrough. The curved tube has a curved tubular section and an affixing sleeve section. The curved tubular section is connected to an end of the positioning piece distal from the head piece, and has an outside portion formed with an elongated groove that extends along length of the curved tubular section, such that two optical fiber lines coupled to the head piece and extending respectively through the through holes of the positioning piece are installed into the curved tubular section via the groove. The affixing sleeve section is connected to an end of the curved tubular section distal from the positioning piece, and is adapted for affixing portions of the optical fiber lines thereon.

Another object of the present invention is to provide an optical fiber connector that can overcome the aforesaid drawbacks of the prior art.

Accordingly, an optical fiber connector of the present invention includes a head piece and a boot. The boot has a positioning piece and a curved tube. The positioning piece is connected to the head piece, and has two parallel through holes formed therethrough. The curved tube has a curved tubular section and an affixing sleeve section. The curved tubular section is connected to an end of the positioning piece distal from the head piece, and has an outside portion formed with an elongated groove that extends along length of the curved tubular section, such that two optical fiber lines coupled to the head piece and extending respectively through the through holes of the positioning piece are installed into the curved tubular section via the groove. The affixing sleeve section is connected to an end of the curved tubular section distal from the positioning piece, and is adapted for affixing portions of the optical fiber lines thereon.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic view of a conventional optical fiber connector;

FIG. 2 is a side view of a first preferred embodiment of a boot according to the invention connected to a head piece;

FIG. 3 is a sectional view of the first preferred embodiment and the head piece;

FIG. 4 is a perspective view of the first preferred embodiment;

FIGS. 5 and 6 are schematic perspective views, illustrating installation of two optical fiber lines into the first preferred embodiment;

FIG. 7 is a perspective view of a variation of the first preferred embodiment;

FIG. 8 is a perspective view of a second preferred embodiment of a boot according to the invention;

FIG. 9 is a schematic perspective view, illustrating installation of two optical fiber lines into the second preferred embodiment;

FIG. 10 is a perspective view of a variation of the second preferred embodiment;

FIG. 11 is a perspective view of another variation of the second preferred embodiment;

FIG. 12 is a perspective view of yet another variation of the second preferred embodiment; and

FIG. 13 is a perspective view, illustrating two optical fiber connectors that respectively have two boots according to the invention, which are arranged to be bent in different directions.

### DETAILED DESCRIPTION OF THE PREFERRED EMBODIMENTS

Before the present invention is described in greater detail, it should be noted that like elements are denoted by the same reference numerals throughout the disclosure.

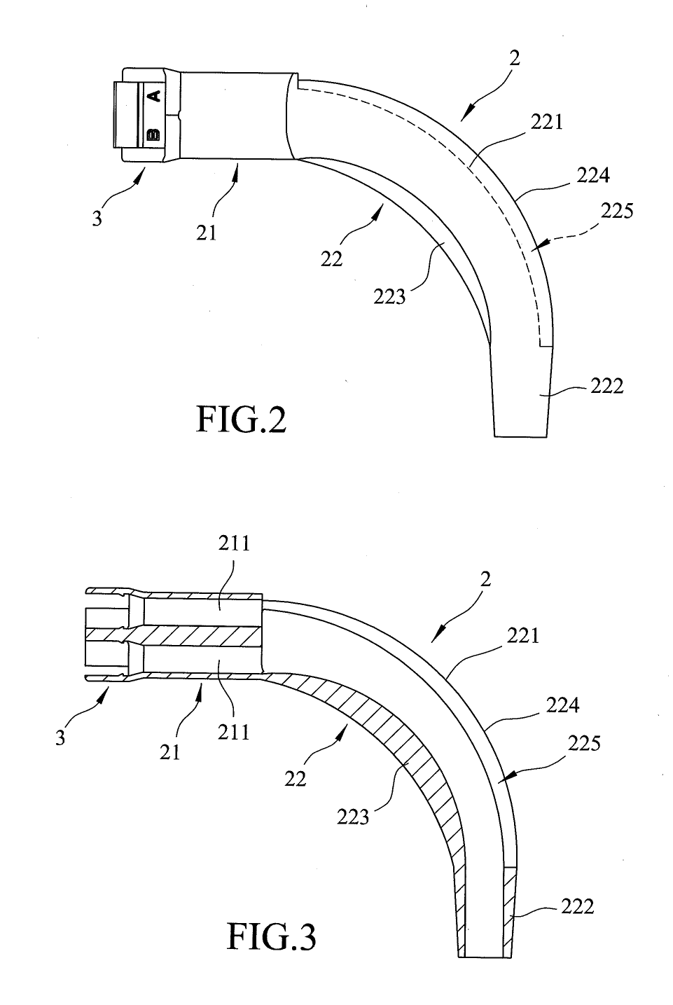

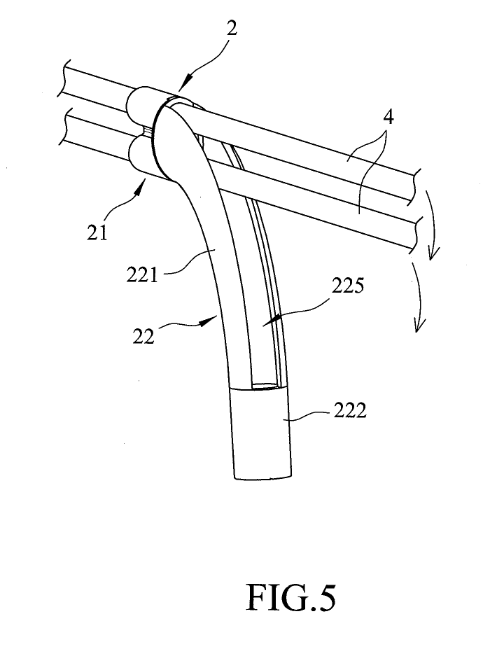

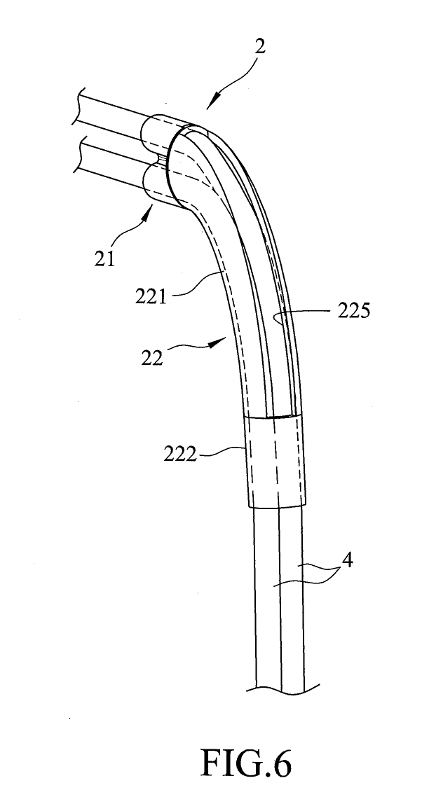

As shown in FIGS. 2, 3 and 4, a first preferred embodiment of a boot 2 according to the present invention is adapted for cooperating with a headpiece 3 to serve as an optical fiber connector that forms two terminals of two optical fiber lines 4 (see FIG. 5), and includes a positioning piece 21 and a curved tube 22. The positioning piece 21 is connected to the head piece 3, has two parallel through holes 211 formed therethrough, and is configured as two parallel and interconnected cylinders (see FIG. 4). In this embodiment, the head piece 3 and the positioning piece 21 are formed as one piece.

The curved tube 22 has a curved tubular section 221 that is connected to an end of the positioning piece 21 distal from the head piece 3, and an affixing sleeve section 222 that is connected to an end of the curved tubular section 221 distal from the positioning piece 21. Each of the through holes 211 of the positioning piece 21 communicates spatially with a space defined in the head piece 3 and a space defined in the curved tubular section 221. The curved tubular section 221 has an inside portion 223 and an outside portion 224 opposite to the inside portion 223. The outside portion 224 is formed with an elongated groove 225 that extends along length of the curved tubular section 221.

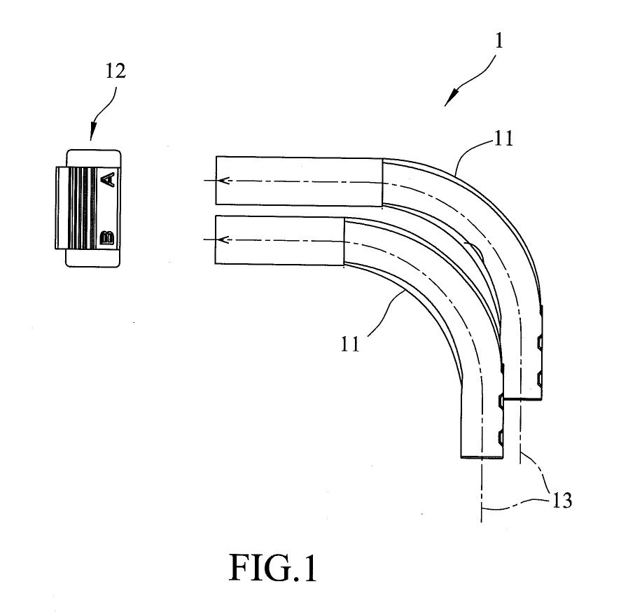

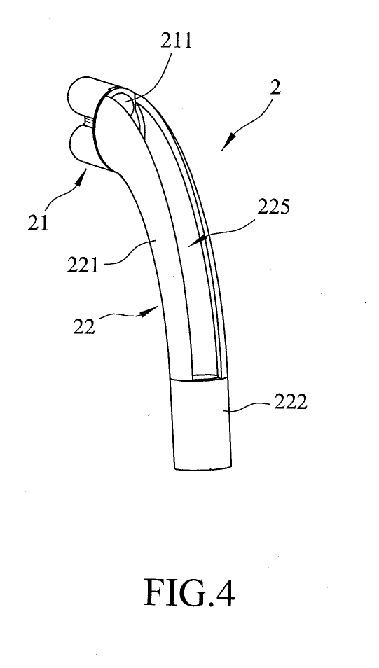

Referring further to FIGS. 5 and 6, in assembly of the boot 2 and the optical fiber lines 4, the optical fiber lines 4 are first coupled to the headpiece 3 (shown in FIGS. 2 and 3), extend respectively through the two through holes 211 of the positioning piece 21, and project out of the curved tubular section 221 via the groove 225. Then, the optical fiber lines 4 are bent and installed into the space in the curved tubular section 221 via the groove 225 and subsequently into the affixing sleeve section 222. Compared with the conventional Lucent connector disclosed in FIG. 1, in this embodiment, the assembly of the optical fiber lines 4 and the boot 2 is relatively easy.

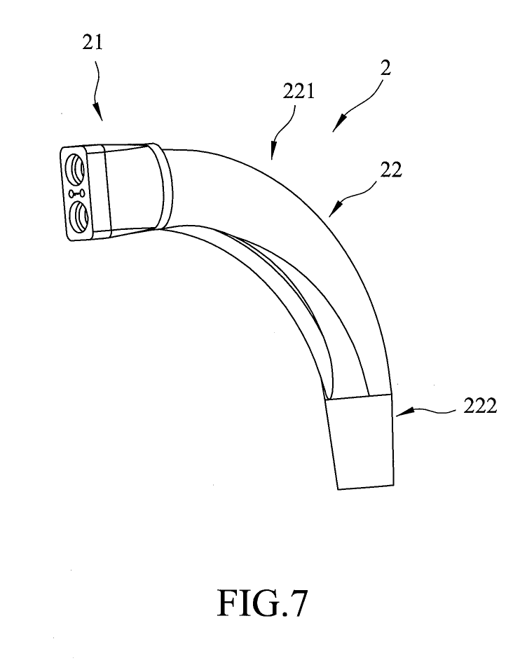

FIG. 7 shows a variation of the first embodiment, which includes a positioning piece 21 that is configured to be rectangular.

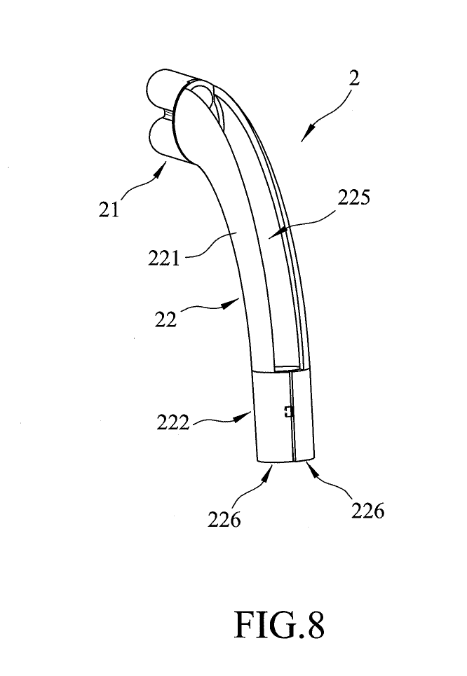

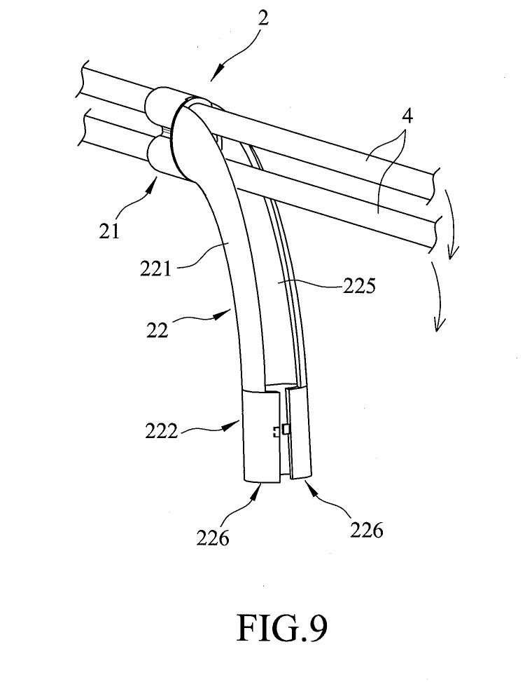

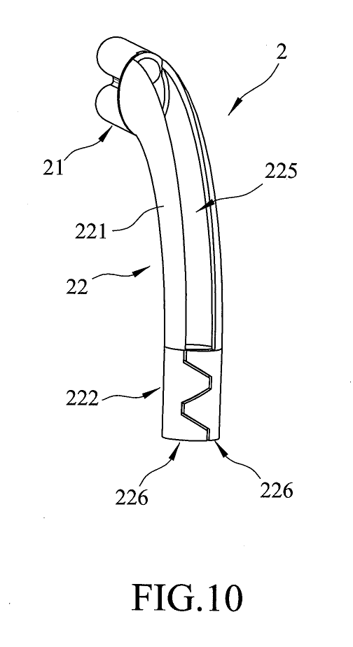

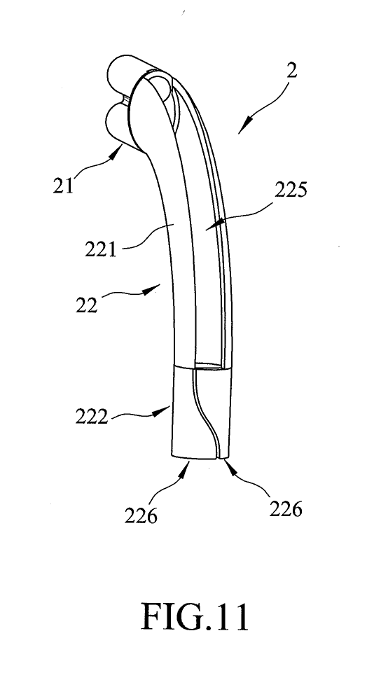

Referring to FIGS. 8 and 9, a second preferred embodiment of the boot 2 according to the present invention includes an affixing sleeve section 222 including two fiber-clamping portions 226 that are interconnected removably to clamp the portions of the optical fiber lines 4 therebetween, and that are removable from each other to release the portions of the fiber lines 4 therefrom. The affixing sleeve section 222 of the second preferred embodiment facilitates installation of the optical fiber lines 4 thereinto since the fiber-clamping portions 226 are removable from each other to form a passageway for passing of the portions of the optical fiber lines 4 therethrough. It is noted that the fiber-clamping portions 226 have interengaging surfaces. The interengaging surfaces may be straight (see FIG. 9), serrated (see FIG. 10) or S-shaped (see FIG. 11).

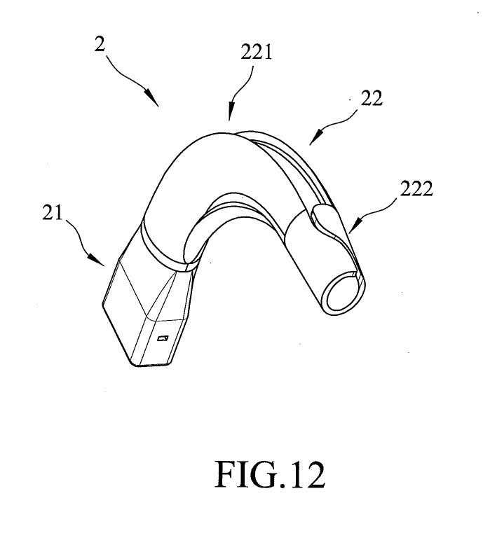

Referring to FIG. 12, a variation of the second preferred embodiment includes an affixing sleeve section 222 that has elliptic cross-section, such that the curved tubular section 221 and the affixing sleeve section 222 have an integrated appearance. Moreover, the positioning piece 21 of this variation is configured to be rectangular.

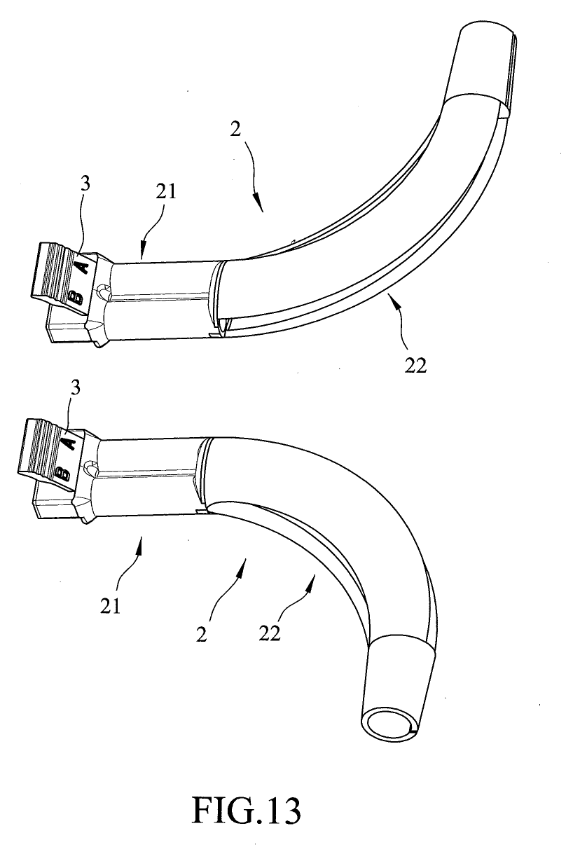

FIG. 13 illustrates that the curved tubular section 221 of the boot 2 according to this invention may be bent away from each other (i.e., in different directions) for being suitable for different occasions.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A boot adapted for cooperating with a head piece to serve as an optical fiber connector, comprising:
a positioning piece adapted to be connected to the head piece and having two parallel through holes that are formed through said positioning piece; and
a curved tube having
a curved tubular section that is connected to an end of said positioning piece distal from the headpiece, and that has an outside portion formed with an elongated groove that extends along length of said curved tubular section, such that two optical fiber lines coupled to the head piece and extending respectively through said through holes of said positioning piece are installed into said curved tubular section via said groove, and
an affixing sleeve section that is connected to an end of said curved tubular section distal from said positioning piece and that is adapted for affixing portions of the optical fiber lines thereon.

2. The boot as claimed in claim 1, wherein said affixing sleeve section includes two fiber-clamping portions that are interconnected removably to clamp the portion of the optical fiber line therebetween and that are removable from each other to release the portion of the fiber line therefrom.

3. The boot as claimed in claim 2, wherein said fiber-clamping portions have interengaging surfaces that are straight.

4. The boot as claimed in claim 2, wherein said fiber-clamping portions have interengaging surfaces that are serrated.

5. The boot as claimed in claim 2, wherein said fiber-clamping portions have interengaging surfaces that are S-shaped.

6. An optical fiber connector comprising:
a head piece; and
a boot that has
a positioning piece connected to said head piece and having two parallel through holes that are formed through said positioning piece, and
a curved tube having
a curved tubular section that is connected to an end of said positioning piece distal from said head piece, and that has an outside portion formed with an elongated groove that extends along length of said curved tubular section, such that two optical fiber lines coupled to said head piece and extending respectively through said through holes of said positioning piece are installed into said curved tubular section via said groove, and
an affixing sleeve section that is connected to an end of said curved tubular section distal from said positioning piece and that is adapted for affixing portions of the optical fiber lines thereon;
wherein said head piece and said positioning piece are formed as one piece.
